(19) United States
(12) Patent Application Publication
(10) Pub. No.: US 2026/0094352 A1
(43) Pub. Date: Apr. 2, 2026

(54) SYSTEMS AND METHODS OF RENDERING TECHNIQUES FOR VIRTUAL STAGES AND SCENES

(71) Applicant: Apple Inc., Cupertino, CA (US)

(72) Inventor: David H. HUANG, San Mateo, CA (US)

(21) Appl. No.: 19/303,092

(22) Filed: Aug. 18, 2025

Related U.S. Application Data
(60) Provisional application No. 63/700,387, filed on Sep. 27, 2024.

(51) Int. Cl. G06T 15/20; G06T 19/20

(52) U.S. Cl. CPC G06T 15/20; G06T 19/20; G06T 2200/24; G06T 2210/36; G06T 2219/024; G06T 2219/2016

(57) ABSTRACT

Some examples of the disclosure are directed to systems and methods for presenting of virtual stages and related virtual content from a virtual scene. In some examples, an electronic device displays virtual content using a first technique at a region that corresponds to a virtual stage within a three-dimensional environment. In some examples, an electronic device displays virtual content using a second technique at a region outside of the virtual stage.

### CROSS-REFERENCE TO RELATED APPLICATIONS

This application claims the benefit of U.S. Provisional Application No. 63/700,387, filed Sep. 27, 2024, the content of which is herein incorporated by reference in its entirety for all purposes.

### FIELD OF THE DISCLOSURE

This relates generally to systems and methods of presenting virtual three-dimensional environments and, more particularly, to presenting of virtual stages and related virtual content from a virtual scene.

### BACKGROUND OF THE DISCLOSURE

Some computer graphical environments provide two-dimensional and/or three-dimensional environments where at least some objects presented for a user's viewing are virtual and generated by a computer. In some examples, virtual three-dimensional environments can be based on one or more images of the physical environment of the computer. In some examples, virtual three-dimensional environments do not include images of the physical environment of the computer.

### SUMMARY OF THE DISCLOSURE

This relates generally to systems and methods of presenting virtual three-dimensional environments and, more particularly, to presenting of virtual stages and related virtual content from a virtual scene. In some examples, an electronic device displays a virtual scene. In some examples, an electronic device displays a virtual stage within a three-dimensional environment. In some examples, a first portion of the virtual scene is rendered using a first rendering technique and is displayed within a virtual stage. In some examples, a second portion of the virtual scene is rendered using a second rendering technique, different from the first rendering technique, outside of the virtual stage. In some examples, a rendering technique is implemented to generate a projected image virtual background. In some examples, a rendering technique is implemented to generate a virtual hologram. In some examples, a rendering technique is implemented to present two-dimensional images that correspond to regions within and surrounding a virtual stage. In some examples, a rendering technique is implemented to generate a multi-planar image corresponding to a virtual background.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIG. 3A-3D illustrates an electronic device presenting a virtual scene using a virtual stage according to some examples of the disclosure.

FIG. 4 illustrates an electronic device displaying a projected virtual background according to some examples of the disclosure.

FIG. 5A-5B illustrates an electronic device displaying a virtual background according to some examples of the disclosure.

FIG. 6 illustrates generation of a virtual background using a two-dimensional image according to some examples of the disclosure.

FIG. 7 illustrates examples of an electronic device generating a multi-planar image according to examples of the disclosure.

FIG. 8 is a flow chart of a method of presenting a virtual scene using a virtual stage according to some examples of the disclosure.

### DETAILED DESCRIPTION

This relates generally to systems and methods of presenting virtual three-dimensional environments and, more particularly, to presenting of virtual stages and related virtual content from a virtual scene. In some examples, an electronic device displays a virtual scene. In some examples, an electronic device displays a virtual stage within a three-dimensional environment. In some examples, a first portion of the virtual scene is rendered using a first rendering technique and is displayed within a virtual stage. In some examples, a second portion of the virtual scene is rendered using a second rendering technique, different from the first rendering technique, outside of the virtual stage. In some examples, a rendering technique is implemented to generate a projected image virtual background. In some examples, a rendering technique is implemented to generate a virtual hologram. In some examples, a rendering technique is implemented to present two-dimensional images that correspond to regions within and surrounding a virtual stage. In some examples, a rendering technique is implemented to generate a multi-planar image corresponding to a virtual background.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

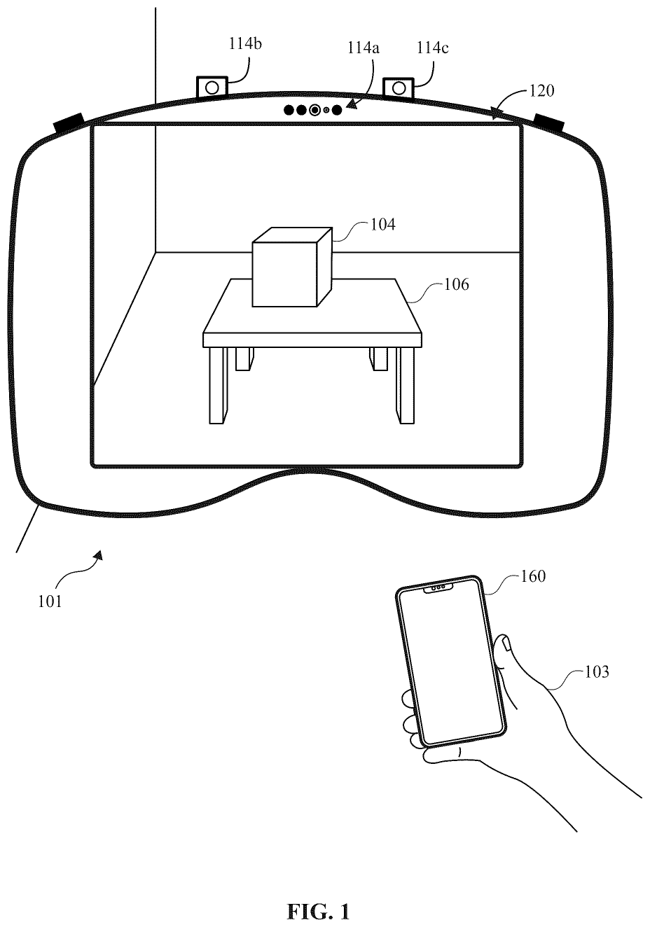

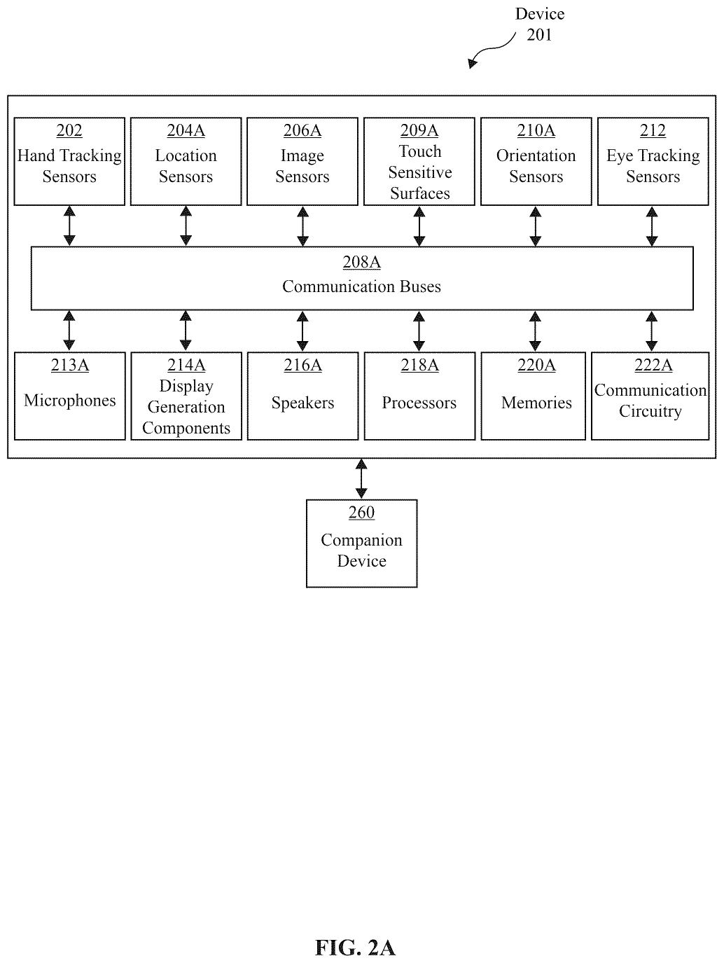

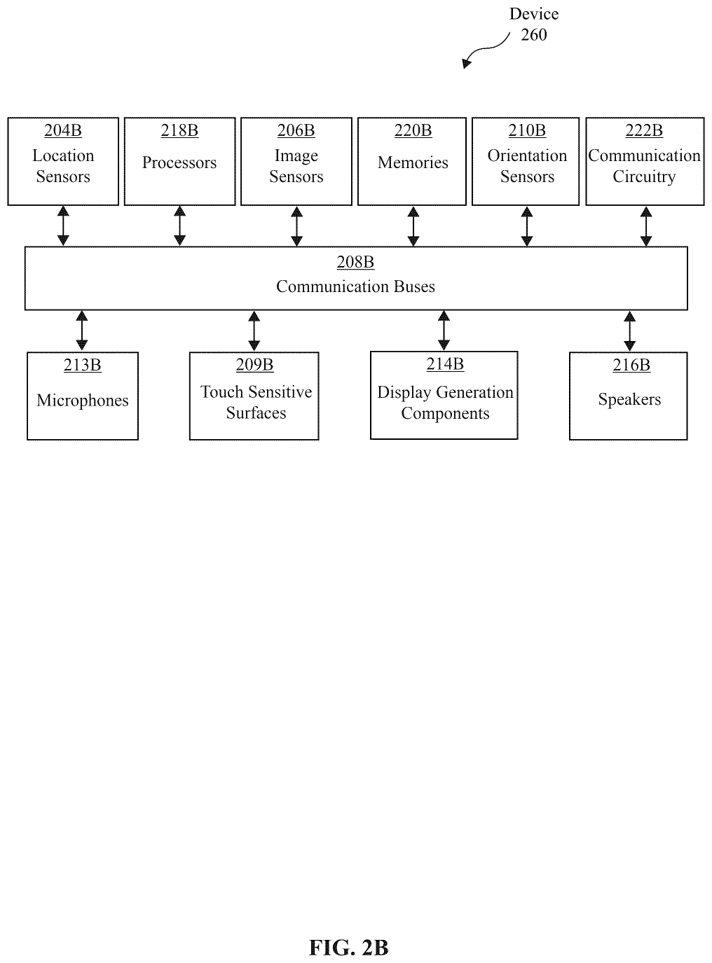

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Some examples of the disclosure are directed to electronic device(s) and/or computer system(s) configured to communicate information to interact with virtual scenes. A virtual scene can include virtual content and/or other information rendered at a particular device for viewing and/or interaction, such as a virtual campground, a virtual office, a virtual meadow, a virtual town, and/or the like. In some examples, the virtual scene can include user and/or computer-generated assets such as a virtual floor, sky, grouping of object(s), and/or metadata relating to such assets.

In some examples, the virtual scene can be displayed at a device. While displaying the virtual scene, a user of the device can view, edit, and/or share comments about contents of the virtual scene. In some examples, the displaying device presents the virtual scene in an extended reality (XR), virtual reality (VR), and/or mixed reality (XR) environment that includes a portion of the virtual scene. In some examples, the virtual scene is displayed using a virtual stage as described further herein. In some examples, the virtual scene is displayed included in a user interface for creating content. For example, the user interface can be for an application that facilitates editing of universal scene description (USD) files, and virtual assets included in the USD files. The user interface and/or the virtual stage can provide a user of the device to inspect the virtual scene, comment about the virtual scene, and/or rapidly collaborate with other users of other devices during inspection of the virtual scene.

In some examples, the displaying device can establish a virtual stage, upon and/or within which virtual content from the virtual scene is displayed. In some examples, the virtual content within the virtual stage is displayed with a first level of detail, including a resolution, appearance, simulated lighting, and/or some combination thereof of virtual assets displayed within the stage. In some examples, the displaying device additionally or alternatively displays virtual content included in the virtual scene, of relatively lesser visual importance such as far-field background virtual assets and/or a virtual sky with a second level of detail, less than or different from the first level of detail. The examples herein enumerate several operations relating to the manner by which the virtual scene is presented using the virtual stage and by which users of device can interact with a virtual scene while displaying a content creating user interface including the virtual stage.

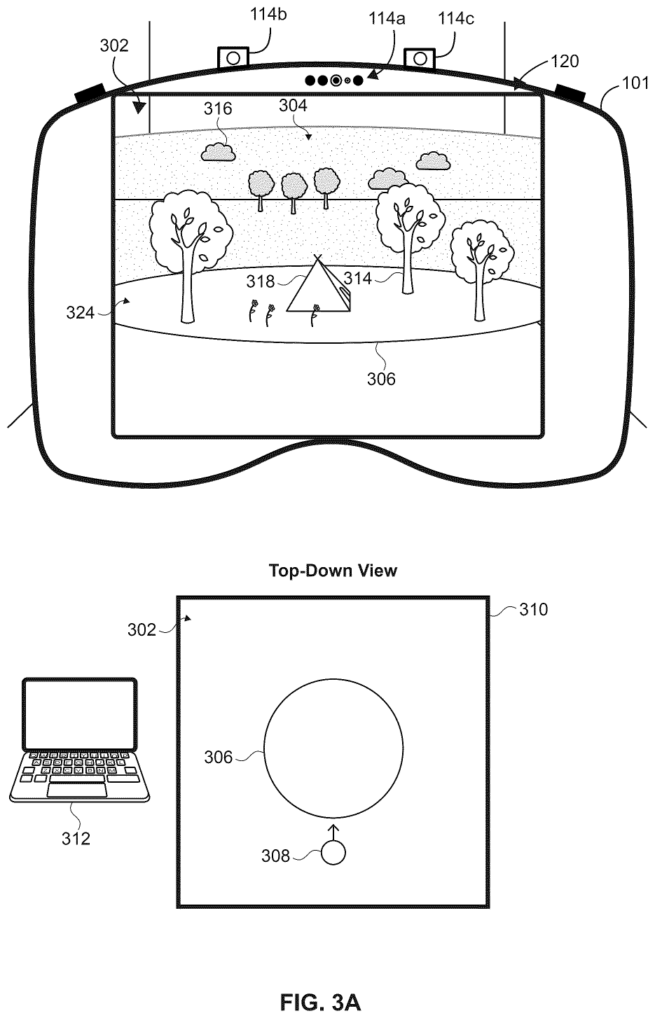

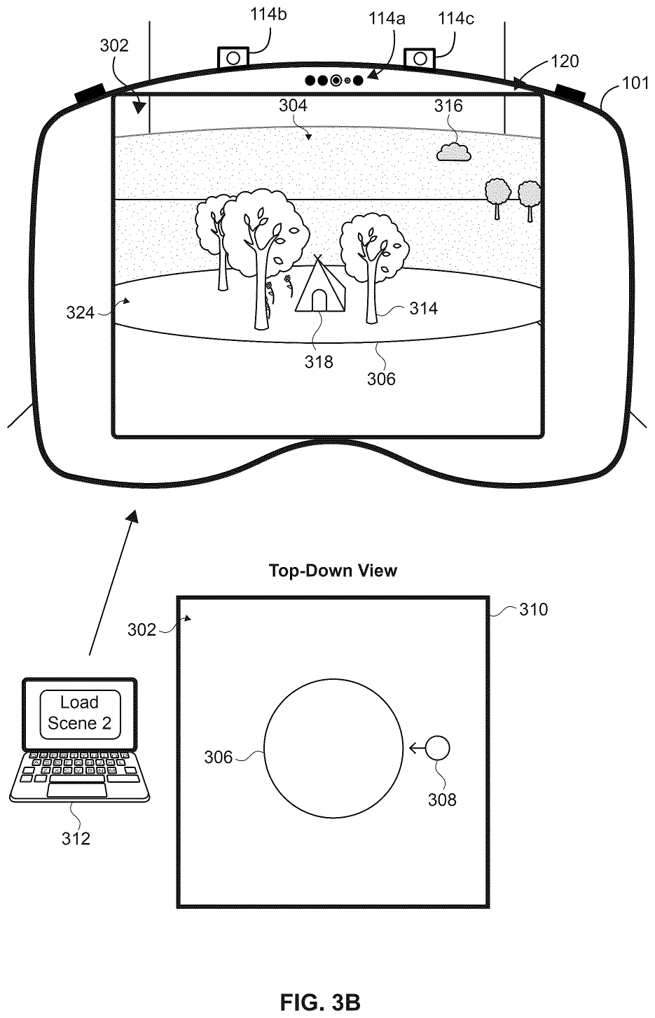

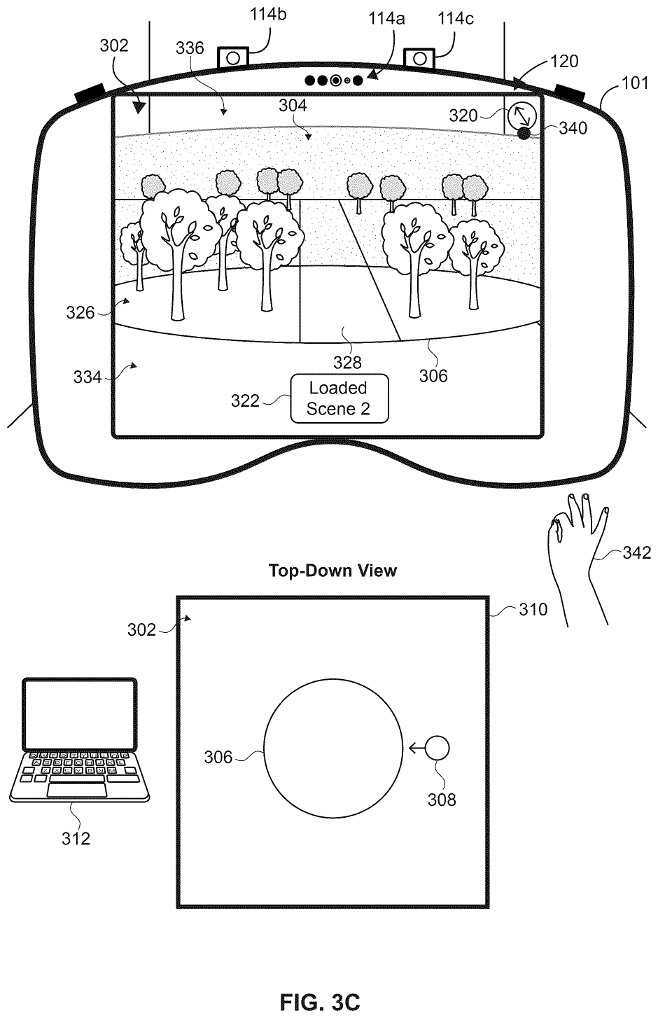

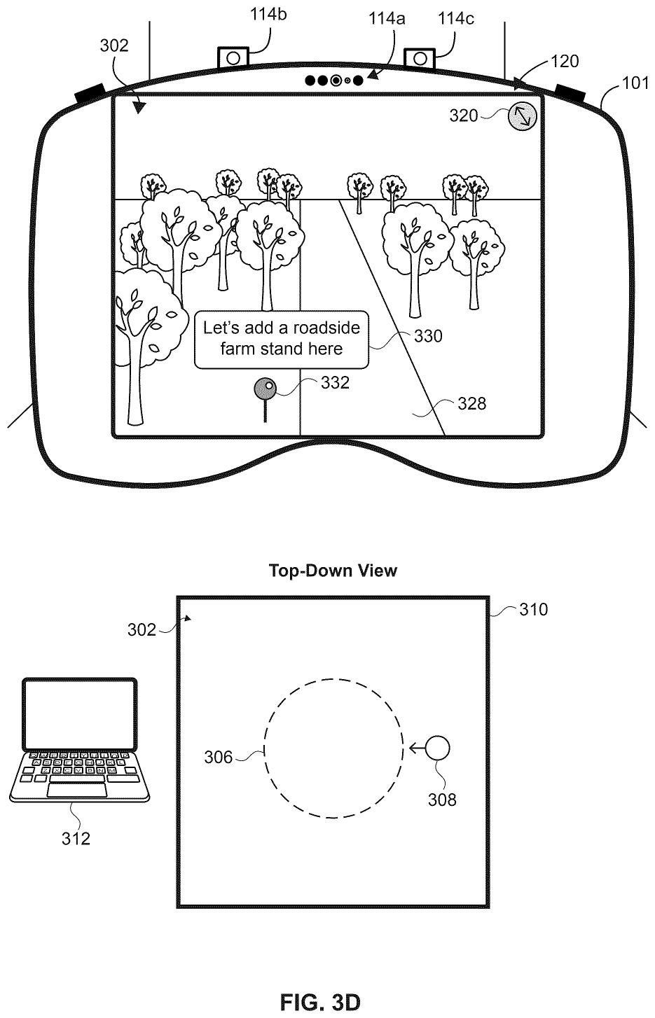

FIG. 3A illustrates an electronic device 101 presenting a virtual scene using a virtual stage according to some examples of the disclosure. In some examples, the electronic device 101 is of the same architecture as electronic device 101 described above with reference to FIG. 1 and/or electronic device 201 described above with reference to FIG. 2.

In some examples, electronic device 101 can be a first electronic device that is used by a first user 308 to display user interfaces for viewing and interacting with virtual content and/or accessing and participating in a communication session. For example, electronic device 101 can be a mobile device (e.g., a tablet, a smartphone, a media player, or a wearable device), or a computer or other electronic device. In some examples, the display generation component is a display integrated with the electronic device (optionally a touch screen display), external display such as a monitor, projector, television, and/or a hardware component (optionally integrated or external) for projecting a user interface or causing a user interface to be visible to one or more users. In some examples, the one or more input devices include an electronic device or component capable of receiving a user input (e.g., capturing a user input, detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device and/or a motion sensor (e.g., a hand tracking device, a hand motion sensor). In some examples, the electronic device is in communication with a hand tracking device (e.g., one or more cameras, depth sensors, proximity sensors, touch sensors (e.g., a touch screen, or trackpad)). In some examples, the hand tracking device is a wearable device, such as a smart glove. In some examples, the hand tracking device is a handheld input device, such as a remote control or stylus.

In some examples, computer system 312 transmits and/or receives (e.g., streams) information such as data. In some examples, computer system 312 includes some or all of the circuitry of electronic device 101 and/or electronic device 201 (e.g., described with reference to FIGS. 1 and 2). In some examples, electronic device 101 and computer system 312 are different types of devices. For example, computer system 312 can be a desktop or laptop computer and electronic device 101 can be a wearable device such as a headset. In some examples, computer system 312 streams the data using one or more data formats, such as JavaScript Object Notation (JSON), extensible markup language (XML), and/or Graphics Library Transmission Format (GLTF). In some examples, computer system and/or electronic device 101 use the streamed data to render and/or otherwise represent scene graphs, object models, animation data, and other graphics-related information.

In some examples, electronic device 101 with computer system 312 communicates using one or more protocols, such as a UDP (User Datagram Protocol) and/or a TCP/IP (Transmission Control Protocol/Internet Protocol) protocol to transmit data packets to and/or receive data packets from computer system 312. In some examples, computer system 312 can host and/or manage XR applications used by electronic device 101 to render displayed virtual content. For example, computer system can implement a client-server architectures where a central computing unit (e.g., computer system 312) manages a state of a virtual environment and sends updates to connected clients (e.g., electronic device 101 and additional or alternative devices).

In some examples, computer system 312 displays virtual content with a Level of Detail (LOD) based on distance between a viewpoint of a user and virtual content. LOD techniques can include the manner by which electronic device 101 changes a displayed level of detail, which can include the level of geometric detail (e.g., the number, shape, and/or arrangement of polygons that represent virtual content), the resolution of virtual textures overlaying and/or included in virtual content, and/or the application of simulating lighting effects to the virtual content. In general, computer system 312 can increase the visual fidelity and/or realism of virtual content that is near a viewpoint of electronic device 101 and/or can decrease the visual fidelity and/or can abstract virtual content that is far away from the viewpoint.

It can be appreciated, as described further herein, that electronic device 101 and/or computer system 312 can additionally or alternatively vary level of detail and/or additional or alternative visual characteristic(s) of virtual content to reduce the computational load required to render the virtual content. In some examples, the computational load is reduced by causing electronic device 101 to display first virtual content that corresponds to a virtual stage area with a first level of detail, and display second virtual content, different from the first virtual content, with a second level of detail, different from the first level of detail. As an example, electronic device 101 can display virtual objects including a virtual floor, virtual trees, virtual cars, virtual roads, and/or the like with a first level of visual fidelity, such that upon inspection, the virtual objects rendered in a virtual stage area are highly detailed for the user's inspection. Concurrently, electronic device 101 can display virtual background content - which can include one or more of the aforementioned virtual objects - with a second level of visual fidelity, which can be lower than the first level of visual fidelity. For example, the background virtual content can be rendered with a smaller number of polygons, can be rendered without a simulated lighting effect and/or a less-nuanced simulated lighting effect, and/or can be rendered with a lower level of resolution than virtual content on a virtual stage.

In some examples, the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment). For example, three-dimensional environment 302 can include the physical environment and/or virtual environment of user 308 and electronic device 101.

As described above, electronic device 101 can present a virtual scene in region corresponding to a stage 306. As described herein, a virtual stage can be a portion of three-dimensional environment 302 where one or more portions of a virtual scene is displayed. For example, as shown in FIG. 3A, stage 306 is mapped to a physical region within 302, indicated by the top-down view of three-dimensional environment 302 illustrated by glyph 310. As illustrated by the display 120 included in electronic device 101, electronic device 101 can display virtual content such as virtual objects, textures, and/or topography. As described further herein and as shown in FIG. 3A, electronic device 101 can display a virtual scene using a plurality of rendering techniques. In some examples, electronic device 101 can display a stage 306 within which a first rendering technique is used to render virtual content from the virtual scene. In some examples, electronic device 101 can display a background 304 which can be rendered using a second rendering technique concurrently while displaying virtual content within stage 306 with the first rendering technique. In some examples, the first rendering technique results in display of virtual content that has a higher degree of visual fidelity than content rendered with the second technique. In some examples, electronic device 101 initiates display of stage 306 and/or the virtual scene in response to detecting user input initiating display of a user interface for creating content. In some examples, electronic device 101 and/or computer system 312 (described further herein) can detect inputs specifying the first and/or second rendering technique, and can display the virtual scene within the user interface for creating content in accordance with the specified rendering techniques.

In some examples, stage 306 and/or the virtual scene can be displayed in response to information received from computer system 312 and/or in response to detecting input initiating and/or approving display of the virtual scene. In some examples, stage 306 can occupy (e.g., be mapped to and/or otherwise correspond to) a predetermined portion of the physical environment. For example, stage 306 can be displayed at with a particular size, spatial profile, and/or overlaying portion(s) of a virtual environment that are determined by computer system 312 and/or electronic device 101.

In some examples, electronic device 101 can initiate display of stage 306 at a predetermined position relative to three-dimensional environment 302 and/or the viewpoint of electronic device 101 with respect to three-dimensional environment 302. For example, electronic device 101 can display stage 306 centered at a first position located in three-dimensional environment 302 in accordance with a determination that electronic device 101 has a first viewpoint relative to the three-dimensional environment 302 (e.g., a first position and/or orientation relative to the physical three-dimensional environment). Electronic device 101 can alternatively display stage 306 centered on a second position, different from the first position, within three-dimensional environment 302 in accordance with a determination that electronic device 101 has a second viewpoint, different from the first viewpoint, relative to three-dimensional environment 302.

In some examples, the portion of the virtual environment displayed within stage 306 can be defined at least in part by computer system 312 and/or electronic device 101. For example, a user of computer system 312 and/or electronic device 101 can specify loading of a first region within the virtual scene, such as a street where a virtual saloon is located when initiating display of the stage 306. Additionally or alternatively, the user can specify loading of a second, different region within the virtual scene, such as a street away from the virtual saloon that includes a virtual bank. In both examples, stage 306 can correspond to a same position and/or location within the physical, and the virtual content displayed in stage 306 can be dependent upon specifying by a user of computer system 312 and/or electronic device 101.

As shown in FIG. 3A, electronic device 101 displays stage 306 including a plurality of virtual objects and/or assets. For example, stage 306 as shown in FIG. 3A includes first content 324. First content 324 includes a portion of a campsite, which includes virtual tree 314 of a plurality of virtual trees, virtual flowers, and a virtual tent 318, which collectively are included in the virtual scene in FIG. 3A. In some examples, the portion of the virtual scene displayed in stage 306 corresponds to a foreground of the virtual scene. Accordingly, electronic device 101 can display first content 324 with a one or more first levels of detail. In some examples, one or more levels of detail include a quality of a render, a count of polygons, a resolution of the virtual content, an application of a simulated lighting effect, a level of detail of a shading model, and/or some combination thereof.

In some examples, electronic device 101 displays virtual content within stage 306 with a first rendering technique. For example, electronic device 101 can use the first technique to display first content 324 with the one or more first levels of detail. It is understood that the specific rendering technique is not limited, but can include one or more of multi-rendering of targeted virtual content, deferred and forward rendering, screen space effects such as ambient occlusion, subsurface scattering, and/or distortion and refraction, stereoscopic rendering, foveated rendering, asynchronous time warping, reprojection, late latching, deferred shading, ray tracing, ray casting, radiosity analysis, path tracing, neural rendering, and/or some combination thereof. It is further understood that in general, virtual content can be rendered to be relatively high resolution portions of images, video, and/or animations presented by electronic device 101 for interaction by a user of electronic device 101. By displaying the virtual content using the first rendering technique, a user of electronic device 101 can inspect a high-fidelity portion of the virtual scene, which can reduce time and efforts to closely inspect virtual assets when creating virtual content using the virtual scene (e.g., images, videos, animations, immersive virtual experiences, and/or using the virtual scene as a backdrop for traditional media such as television and/or film).

In some examples, electronic device 101 displays virtual content outside of stage 306 with a second rendering technique, different from the first rendering technique. In some examples, implementing display of virtual content with the second rendering technique includes displaying the virtual content outside of stage 306 with a second level of detail, different from the first level of detail. It is understood that the second rendering technique can include one or more characteristics similar to, or the same as described with reference to the first rendering technique. In some examples, the second rendering technique can differ from the first technique, by way of omitting one or more of the techniques, setting different thresholds for algorithms used to determine the manner of display of virtual content, by including certain one or more techniques not included in the first rendering technique, and/or some combination thereof.

In general, it is understood that by displaying virtual content with the second technique, electronic device 101 can reduce the computation required to display the virtual content as compared to displaying the same virtual content with the first rendering technique. As an example, electronic device 101 can display virtual cloud 316 with a resolution that is lower than if virtual cloud 316 were included in stage 306. Additionally or alternatively, virtual cloud 316 can move with a simulated parallax effect in response to detecting movement of a viewpoint of electronic device 101. In some examples, the virtual content outside of stage 306 corresponds to a midground and/or background of the virtual scene. In some examples, electronic device 101 can render other portions of the virtual scene concurrently with stage 306 and/or background 304, such as by using a third rendering technique, different from the first and/or second technique.

In FIG. 3A, user 308 is within three-dimensional environment 302, and has a viewpoint similar to or the same as the viewpoint of electronic device 101 described herein. User 308 at times is referred to herein as a first user (e.g., a user of electronic device 101), and a user of computer system 312 can be a second user. It can be appreciated, however, that designations between a user and a device are merely illustrative examples. For example, a single individual can be a user of both electronic device 101 and computer system 312.

FIG. 3B illustrates display of a user interface for content creation including a virtual stage. In some examples, electronic device 101 updates the perspective of virtual content with respect to stage 306 and/or background 304 in accordance with movement of a viewpoint of user 308. From FIG. 3A to FIG. 3B, electronic device 101 detects movement of the viewpoint of electronic device 101 (e.g., the movement is detected while displaying stage 306 and/or background virtual content as shown in FIG. 3A). For example, the viewpoint of electronic device 101 moves radially around the stage 306 as shown in glyph 310. In some examples, in response to detecting the movement of the viewpoint, electronic device 101 updates display of the virtual scene. For example, in FIG. 3B, electronic device 101 maintains display of a first portion of the virtual scene (e.g., first content 324), changing the perspective of the first portion in accordance with the movement of the viewpoint. The updated perspective, for example, can visually appear as though the user 308 were physically moving relative to a physical equivalent of stage 306. Thus, electronic device 101 can update the first portion of the virtual scene displayed in stage 306 in direction(s) and/or by amount(s) similar to, or the same as direction(s) and/or amount(s) of movement of the viewpoint movement.

As shown in FIG. 3B, electronic device 101 updates stage 306 to show a profile of the tent 318, virtual tree 314, and additional content included in stage 306. Similarly to the techniques described with reference to FIG. 3A, electronic device 101 maintains display of the first portion of the virtual scene with the first rendering technique.

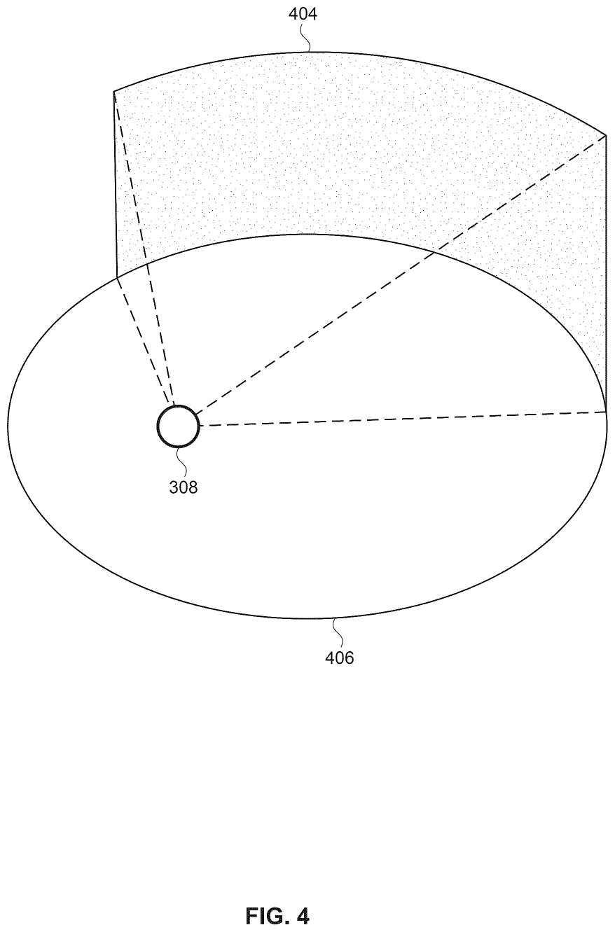

In FIG. 3B, electronic device 101 displays the portion of the background 304 displayed with the second rendering technique in accordance with the movement of the viewpoint of electronic device 101. For example, from FIG. 3A to FIG. 3B, electronic device 101 ceases display of virtual cloud 316 (in addition to other virtual background content) and initiates display of virtual content not displayed prior to detecting the viewpoint of movement. For example, as illustrated in FIG. 3B, electronic device 101 displays additional details of the virtual sky and the region of the virtual scene that is behind the virtual stage. Thus, computer system 312 and/or electronic device 101 can map the movement of the viewpoint of the user relative to three-dimensional environment 302 to the stage 306 and can initiate display and/or cease display of virtual content in virtual background 304. By mapping the movement relative to the stage 306, and by using knowledge of the spatial arrangement between the virtual content included in stage 306 and the virtual scene, electronic device 101 can display background 304 in accordance with movement of the viewpoint (e.g., as described with reference to FIGS. 4A through 6).

In FIG. 3B, computer system 312 detects an input and displays information indicative of that input (e.g., “load scene 2”). For example, computer system 312 can detect a voice command, a selection of a selectable option (e.g., a button, a menu item, an icon, and/or media), and/or an air gesture (e.g., an air pinching of two fingers, an air swiping of one or more fingers, and air curling of one or more fingers) directed toward computer system 312, and can initiate a request to cause electronic device 101 to update a displayed virtual scene. In response to detecting the input, the computer system 312 can cause electronic device 101 to display a new virtual scene, as described in more detail below with reference to FIGS. 3C through 3D.

From FIG. 3B to FIG. 3C, electronic device 101 updates stage 306 to include second content 326, which can correspond to a different virtual scene than the virtual scene shown in FIG. 3B. In some examples, the virtual scene corresponds to a different region within a same virtual environment as the virtual scene shown in FIG. 3B. In some examples, the virtual scene corresponds to a different virtual environment entirely. For example, because computer system 312 requested (and although not shown, electronic device 101 can approve) display of a new virtual scene, electronic device 101 can cease display of a previously displayed virtual scene and initiate display of a replacement virtual scene. While transitioning between the virtual scenes, electronic device 101 can maintain display of an indication of stage 306, such as a border corresponding to the stage 306.

FIG. 3C, for example, illustrates electronic device 101 displaying a new scene (e.g., “Scene 2” as indicated by visual indication 322). Second content 326, included in the virtual scene, includes new virtual assets such as road 328, in addition to additional virtual assets such as trees that were not displayed in FIG. 3B. Electronic device 101, as shown in FIG. 3C, can display second content 326 with the first rendering technique (e.g., because the portion of the virtual scene including second content 326 is what is bound by stage 306).

In addition to the updates to virtual content in stage 306, electronic device 101 can update display of background 304 in accordance with the request to display the new virtual scene. For example, FIG. 3C illustrates additional virtual assets such as virtual trees included in background 304, which can be displayed with the second rendering technique. Thus, electronic device 101 can display a first portion of the first virtual scene with the first rendering technique, and can display a second portion the virtual scene with a second rendering technique. Additionally or alternatively, electronic device 101 can display a third portion of the virtual scene (or a respective portion of the second virtual scene) with the first rendering technique while displaying a fourth portion of the first virtual scene (or a respective portion of the second virtual scene) with the second rendering technique.

In FIG. 3C, because road 328 extends through and outside of the portion of virtual scene bound by stage 306, electronic device 101 displays road 328 with the first and the second rendering technique. A first portion of the road 328 within stage 306 can be displayed with the first rendering technique and a second portion of road 328 outside of stage 306 can be displayed with the second rendering technique.

In FIG. 3C, electronic device 101 forgoes displaying (e.g., does not display) virtual content corresponding to region 334 of the display 120 (e.g., between the viewpoint of electronic device 101 and stage 306) and corresponding to region 336 of display 120 (e.g., above background 304). Accordingly, electronic device 101 can present visibility of the physical rooms and/or features within three-dimensional environment, such as the physical walls, ceiling, and/or floor of three-dimensional environment 302. As described with reference to display 120, electronic device 101 can present portions of the physical environment in a field of view of electronic device 101. Accordingly, three-dimensional environment 302 can include optically transparent and/or video-passthrough views of the physical environment within which electronic device 101 is located.

In some examples, electronic device 101 detects input requesting changing of display of the virtual scene. In response to detecting the input, electronic device 101 can change presentation of the virtual scene in accordance with the request. For example, the change can include one or more of a displayed level of immersion of the virtual scene, a location of stage 306, a size of stage 306, a spatial profile of stage 306, which rendering technique(s) are used to display the virtual scene within stage 306 and/or outside of stage 306, the specific virtual scene that is displayed, and/or display of virtual annotations associated with the virtual scene.

As an example, electronic device 101 can detect one or more inputs such as an air pinch directed toward a stage 306, such as a selectable option overlaying stage 306 (e.g., a button or icon of a plurality of buttons or icons overlaying the border of stage 306). While the air pinch including contact between a plurality of fingers is maintained, electronic device 101 can detect movement of the hand forming the air pinch, and can scale the stage 306 in one or more directions by one or more amounts corresponding to one or more directions and/or one or more amounts of movement of the air pinch and/or hand. In some examples, in response to detecting inputs increasing the size of stage 306, electronic device 101 initiates display of additional portions of the virtual scene, such as a third portion of the virtual scene, within stage 306. In some examples, in response to detecting inputs decreasing the size of stage 306, electronic device 101 ceases display of respective virtual content included in the first portion of the virtual scene (e.g., ceases display of virtual content included in stage 306 prior to detecting the inputs, and based on where and/or by what degree stage 306 contracts).

As an additional or alternative example, electronic device 101 can detect one or more inputs directed toward a grabber (e.g., a selectable option such as an icon or button) and in response can initiate a movement of stage 306. In response to detecting a selection input such as an air pinching of two or more fingers, electronic device 101 can initiate movement in one or more directions by one or more amounts corresponding to one or more directions and/or one or more amounts of movement of the air pinch and/or hand forming the air pinch. In response to detecting the movement, electronic device 101 can update the location of stage 306. In some examples, the “on stage” portions of the virtual environment can change in accordance with the movement. Thus, in response to detecting movement of stage 306, electronic device 101 can initiate display of virtual content and/or cease display of virtual content in accordance with an updated position of stage 306 relative to the virtual scene.

In some examples, the input can be directed toward a physical or virtual button which can be configured to perform different functions in accordance with the type of input directed toward the button. For example, electronic device 101 can change a level of immersion of the virtual scene in accordance with a rotating of a physical button included in electronic device 101, and/or can perform additional or alternative operations such as moving stage 306 to a location a predetermined distance away from the viewpoint of electronic device 101 in response to detecting pressing of the button.

In FIG. 3C, electronic device 101 detects input from hand 340 while attention 342 is directed toward selectable option 320. In some examples, selectable option 320 is selectable to change how the virtual scene shown in stage 306 is presented. For example, selectable option can be representative of a user interface element selectable to increase the “level of immersion” of the virtual scene relative to three-dimensional environment 302. In some examples, the level of immersion includes or corresponds to the degree to which virtual content consumes a viewport of electronic device 101. In some examples, the level of immersion additionally or alternatively includes visual characteristics of the virtual scene, such as an opacity, brightness, saturation, level of resolution, and/or some combination thereof.

In some examples, electronic device 101 changes how the virtual scene is presented in accordance with requests to change a “level of immersion” of the virtual scene. In FIG. 3D, electronic device 101 presents the virtual scene with a level of immersion higher than the level of immersion shown in FIG. 3C. For example, electronic device 101 displays the virtual scene entirely occupying the viewport of electronic device 101 in FIG. 3D. Thus, electronic device 101 displays the virtual scene with a relatively high level of immersion relative to three-dimensional environment 302. In some examples, while displaying the virtual scene with the level of immersion shown in FIG. 3D, electronic device 101 displays additional portions of the virtual environment in response to detecting movement of the viewpoint of electronic device 101 while maintaining the level of immersion. For example, electronic device 101 can detect movement of a head of a user 308 wearing electronic device 101 relative to three-dimensional environment 302, and in response, can display portions of virtual scene similar to as though the user 308 were looking at a physical equivalent of the virtual scene.

In some examples, electronic device 101 expands the amount of virtual content displayed via display 120 in accordance with the increase in level of immersion. For example, electronic device 101 displays new virtual trees, portions of a virtual floor, and/or portions of the virtual sky in response to detecting the input shown in FIG. 3C. In particular, regions 334 and 336 that did not include virtual content from the virtual scene in FIG. 3C include virtual content from the virtual scene in FIG. 3D.

In some examples, when increasing the level of immersion, electronic device 101 changes the rendering technique used to display portions of three-dimensional environment 302. For example, electronic device 101 in FIG. 3D can display portions of the virtual scene corresponding to background 304 shown in FIG. 3C with the first rendering technique, thus increasing the visual fidelity of the background region. Thus, electronic device 101 can improve the realism of the background of the virtual scene by using the first rendering technique to display the background.

In some examples, electronic device 101 can maintain display of background content with the second rendering technique. For example, electronic device 101 can maintain display of the portions of the virtual scene that correspond to background 304 shown in FIG. 3C with the second technique in response to detecting the input provided by hand 340 shown in FIG. 3C. Thus, electronic device 101 can reduce the computational load required to display the background of the virtual scene in FIG. 3D by displaying the background with the second rendering technique.

In FIG. 3D, electronic device 101 ceases display of the stage (e.g., stage 306 in FIG. 3C). In some examples, the ceasing is performed in response to detecting the input shown in FIG. 3C. In some examples, electronic device 101 maintains and/or changes display of a visual indication of the stage. For example, electronic device 101 can display a border corresponding to the stage within three-dimensional environment 302 in FIG. 3D. In some examples, the border is displayed with a visual characteristic to distinguish the border from three-dimensional environment 302, such as with a simulated glowing effect, a level of opacity, a color, a brightness, and/or some combination of such characteristics.

In some examples, the virtual scene includes annotations directed to virtual content included in the virtual scene. For example, electronic device 101 and/or computer system 312 can communicate to present the virtual scene while editing the content of the virtual scene. In some examples, users of the devices enter annotations such as text, simulated handwriting, comments, voice records, virtual markers, spatial recordings of users moving throughout the virtual scene, and/or the like within the virtual scene. In some examples, electronic device 101 and/or computer system 312 display visual indications of the annotations at locations specified by the user's and/or locations generally directed toward the virtual scene. For example, pin 332 in FIG. 3D can correspond to a visual marker provided by user 308 while inspecting the road 328. In some examples, the annotation includes information 330, which is concurrently displayed with visual indication 322 and describes a comment entered by user 308. Thus, electronic device 101 can display visual representations of annotations, thereby reducing processing and context switching incurred by requesting display of a list of annotations and cross-referencing the list with potentially relevant portions of the virtual scene.

As described with reference to FIGS. 3A-3D, electronic device 101 can display virtual backgrounds included in a virtual scene using one or more rendering techniques. In some examples, the rendering techniques implemented by electronic device 101 decreases the amount of processing and/or pre-rendering required to display the virtual background. Additionally or alternatively, using different rendering techniques may reduce the amount of data that is sent from a computer system to electronic device 101 when streaming data to display the virtual scene.

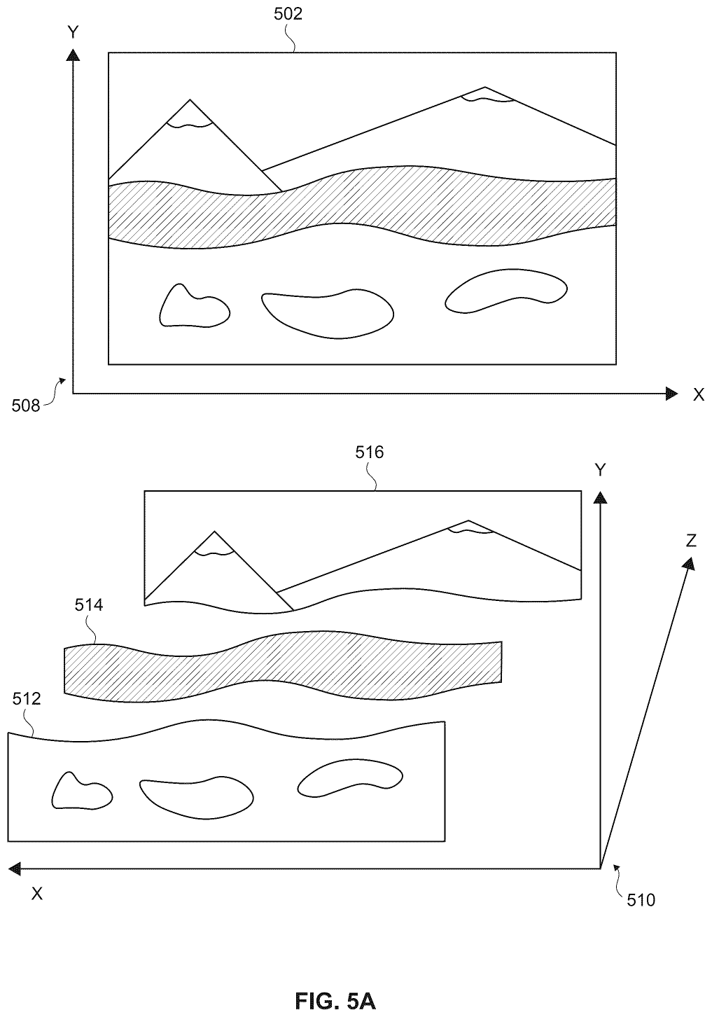

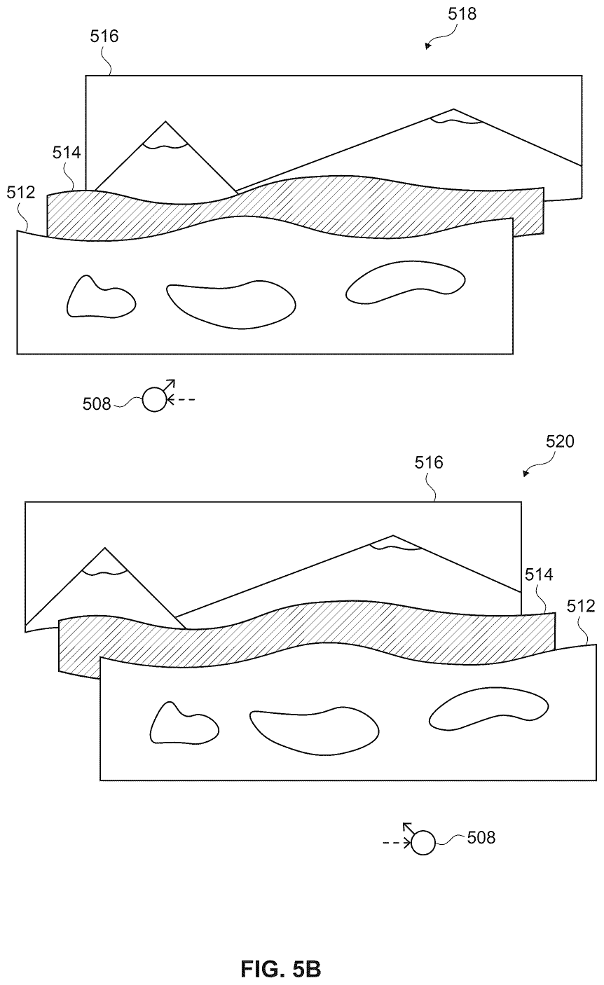

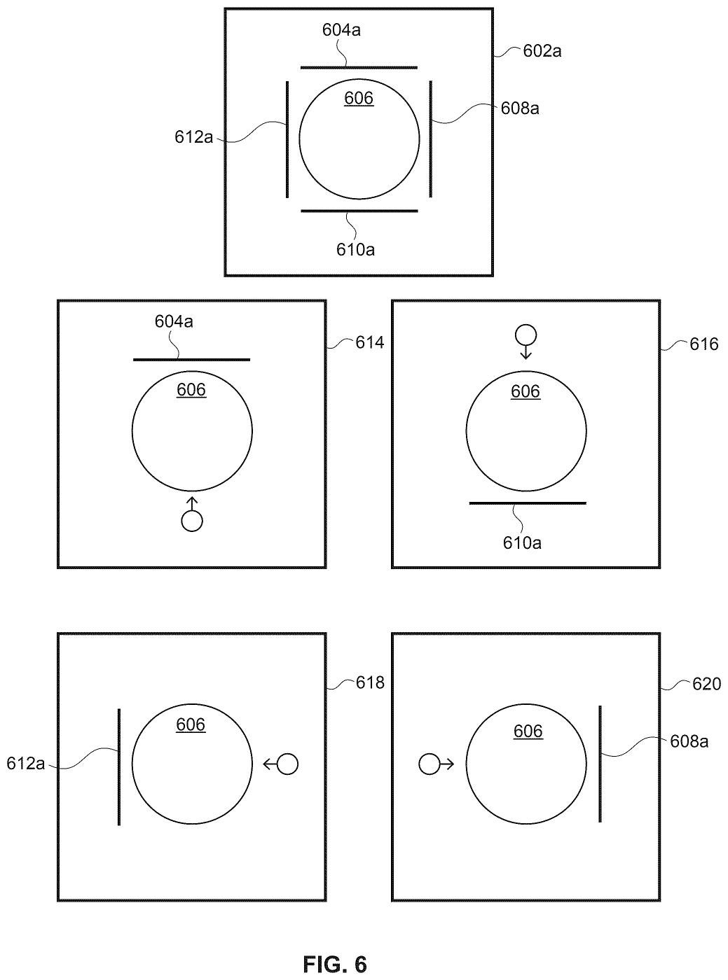

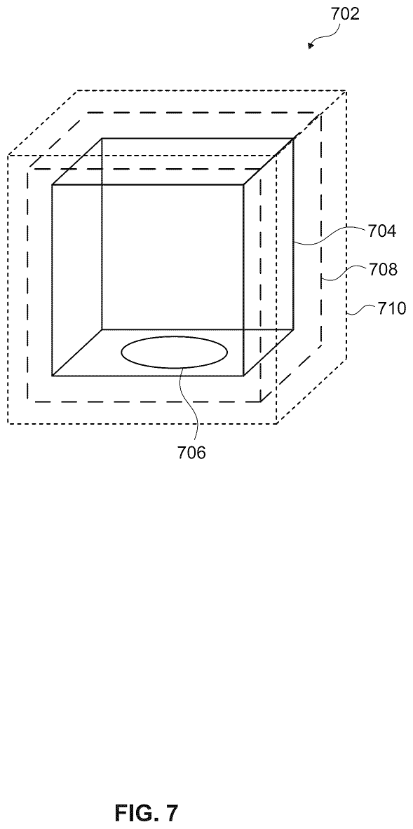

As described further with reference to FIG. 4, a rendering technique can include displaying a two-dimensional image, such as a segment of a panoramic background image. As described with reference to FIGS. 5A-5B, a rendering technique can include displaying the virtual background by detecting visual features in a two-dimensional image of a virtual background, and extracting and/or stacking the extracted visual features to create a simulation of depth. As described with reference to FIG. 6, a rendering technique can include determining zones of the three-dimensional environment relative to a virtual stage, and displaying a background image that corresponds to the zone. As described with reference to FIG. 7, a rendering technique can include determining a plurality of volumes relative to a virtual stage, and displaying one or more multi-planar images, determining virtual content that exists in the virtual scene and intersecting with the surfaces of the volume, and generating the one or more multi-planar images by compositing the determined virtual content.

FIG. 4 illustrates an electronic device displaying a projected virtual background according to some examples of the disclosure. For example, in FIG. 4, the viewpoint of electronic device 101 is located within virtual stage 406, and electronic device 101 projects a plurality of rays to determine a virtual background based on where the rays intersect with a projection of the virtual stage 406. In some examples, electronic device 101 generates a virtual background by projecting one or more rays from a viewpoint of electronic device 101 toward a virtual stage. As shown in FIG. 4, electronic device 101 (and/or a computer system in communication with electronic device 101) can project one or more rays from the viewpoint of electronic device 101 toward the periphery of virtual stage 406, and can determine an intersection between the rays and a boundary and/or a projection of virtual stage 406 (e.g., normal to virtual stage 406 and/or normal to a floor below virtual stage 406). Electronic device 101 and/or the computer system can detect the intersection, and can display background 404 in accordance with the intersection. For example, the projection can encompass at least a part of a virtual scene (e.g., similar to, or the same as background 304 as shown in FIG. 3A). In some examples, the virtual stage corresponds to a region in the three-dimensional environment. The region can be predefined (e.g., when instantiating the virtual scene and/or in response to inputs initiating display of the virtual scene and/or virtual stage 406). In some examples, the region is at least temporarily anchored to a portion of the physical environment. In some examples, the portion of the physical environment is predetermined (e.g., in a manner similar to or the same as described with reference to the region). In some examples, the region is circular, rectangular, polygonal, or three-dimensional (e.g., dome-shaped, cylindrical, cubic, and/or prismatic) in shape. In some examples, the region is a hybrid shape including one or more of the aforementioned shapes. Regardless of the shape of the region, electronic device 101 can detect an intersection between rays originating from the viewpoint of the user, and intersecting with a region (or a projection of the region) within the three-dimensional environment. The intersection can define the size, location, and/or spatial profile of displayed virtual background content. Generating images at electronic device 101 using a projection of the viewpoint of the suer relative to virtual stage 406 reduces the processing required to render images and virtual content that does not correspond to the viewpoint of the user as defined relative to virtual stage 406, thereby improving the efficiency of electronic device 101.

In some examples, the orientation of the rays is defined by electronic device 101 and/or the computer system in communication with electronic device 101. For example, a setting established when initiating the computer system can define an aspect ratio, size, one or more dimensions, and/or an angular range that the projected background, background 404, can encompass.

In some examples, electronic device 101 updates the projected background 404 in accordance with movement of the viewpoint. For example, in response to detecting movement of the viewpoint of electronic device 101 from a first to a second viewpoint, electronic device 101 can detect an intersection between a plurality of rays cast based on the viewpoint change from a first intersection to a second intersection. Electronic device 101 can determine that the intersection defined by the projected rays captured a first portion of the virtual scene while the viewpoint was the first viewpoint, and can determine that the intersection defined by the projected rays captures a second portion of the virtual scene when the viewpoint is the second viewpoint. Accordingly, in response to detecting the change in viewpoint, electronic device 101 can cease display of virtual content included in background 404 that is not bound by the projection generated relative to the second viewpoint, and can initiate display of virtual content in background 404 that is newly bound by the projection relative to the second viewpoint.

In some examples, the viewpoint of electronic device 101 is outside of the virtual stage 406 and is generally oriented toward virtual stage 406. In some examples, in accordance with a determination that the one or more of the rays do not intersect with a projection of virtual stage 406, electronic device 101 can limit the dimensions of the projected background 404. For example, electronic device 101 can detect that the rays cast rightward relative to electronic device 101 are to the right of, and does not intersect with, the projection of virtual stage 406 extending toward a ceiling of a three-dimensional environment. In this example, electronic device 101 can set a limit on the relative location of a right edge of background 404. For example, if the projection of virtual stage 406 that defines where background virtual content is displayed corresponds to a cylindrical sheet extending normal to virtual stage 406, electronic device 101 can display the virtual background overlaying portions of the cylinder where the interior surface of the cylinder is visible from the user's viewpoint.

As described with reference to FIGS. 5A-5B, a rendering technique can include displaying the virtual background by detecting visual features in a two-dimensional image of a virtual background, and extracting and/or stacking the extracted visual features to create a simulation of depth. In some examples, a rendering technique implemented to display background virtual content from a virtual scene includes generating one or more images such as stereoscopic images that exhibits parallax effects in response to detecting movement of an electronic device viewpoint relative to the one or more images. In some examples, the stereoscopic images are generated using one or more artificial intelligence models that take a two-dimensional image as an input, and generate a stereoscopic image and/or a virtual hologram.

In FIG. 5A, image 502 can be a two-dimensional image of a virtual background from a virtual scene, as indicated by axes 508. The two-dimensional image can be generated by a user of electronic device 101 and/or a computer system that communicates image 502. In some examples, the two-dimensional image is processed by electronic device 101, the computer system, one or more servers, and/or some combination thereof. In some examples, the processing of image 502 includes using one or more artificial intelligence models to determine visual features of image 502 and/or determine a simulated depth of the visual features. For example, electronic device 101 can implement monocular depth estimation using one or more deep neural networks to determine depth information about visual features included in image 502.

The visual features, for example, can include content 512 through 516. Content 512 can include a ground texture and a plurality of bodies of virtual water. Content 514 can include a virtual fog that overlays content 516, which can include mountain peaks in a far-field of the virtual scene. As shown in FIG. 5A, electronic device 101 can determine and/or receive an indication of depth information obtained from the processing of image 502 using the one or more artificial intelligence models, as indicated by the depth axis (e.g., “Z”) included in axes 510.

In some examples, electronic device 101 uses the determined depth information to present a simulation of depth with respect to content 512 through 516. FIG. 5B, for example, illustrates differing spatial arrangement 518 and 520 presented to user 308 in response to detecting movement of viewpoint of electronic device 101. By modifying a spatial arrangement between visual features extracted from a two-dimensional image, electronic device 101 can simulate the perception of depth, lending realism to virtual background without necessarily requiring implementation of more computationally taxing simulations of depth. Thus, electronic device 101 can present a virtual hologram by causing content 512 through 516 to float in one or more directions and/or by one or more amounts based on one or more directions and/or one or more amounts of movement of the viewpoint of electronic device 101.

Spatial arrangement 518, for example, illustrates an example in which the viewpoint of electronic device 101 moves left of a perceived lateral center of content 512 through 516. In response to detecting the leftward movement, electronic device 101 can animate content 512 through 516. In some examples, the animation includes laterally shifting content 512 through 516 relative to each other, laterally staggering content 512 through 516. As shown in FIG. 3B, content 512 is leftmost, 514 is intermediate, and content 516 is rightmost relative to the viewpoint of electronic device 101. By staggering the constituent portions of the virtual background generated using the one or more artificial intelligence models, electronic device 101 can simulate the appearance of a hologram, thereby lending a perception of depth to the virtual background that comprises content 512 through 516.

Spatial arrangement 520 illustrates an example in which the viewpoint of electronic device 101 moves right of a perceived lateral center of content 512 through 516. In particular, spatial arrangement 520 can reflect a staggering of content 512 through 516 (e.g., content 512 is the rightmost, 514 is intermediate, and content 516 is leftmost) relative to the viewpoint of electronic device 101. Thus, as the viewpoint of electronic device 101 changes laterally relative to content 512 through 516, electronic device 101 can simulate depth by animating lateral shifts of content 512 through 516. Displaying content that shifts relative to one another based on changes in viewpoint of electronic device 101 reduces the computation required for the electronic device 101 to render a more detailed representation of a virtual scene while providing feedback to the user about the moving of the viewpoint of electronic device 101 relative to the virtual scene, thereby reducing the processing required to display the more detailed representation of the virtual scene while reducing the likelihood that electronic device 101 performs operations based on erroneous changes in viewpoint of electronic device 101.

FIG. 6 illustrates an electronic device displaying a virtual background image according to some examples of the disclosure. In some examples, electronic device 101 determines a spatial arrangement between a viewpoint of electronic device 101 and a virtual stage, and displays a two-dimensional background image in accordance with the spatial arrangement. Spatial arrangements 614 through 620 shown in FIG. 6, for example, illustrate different example spatial arrangements between user 308 and virtual stage 606. In such examples, electronic device 101 displays a predetermined background image that corresponds to the location of electronic device 101 relative to virtual stage 606. Thus, electronic device 101 can display a background image that corresponds to a “zone” within a three-dimensional environment.

In some examples, electronic device 101 maps one or more regions relative to virtual stage 606 to one or more background images. For example, image 604a can correspond to a first region, image 608a can correspond to a second region, image 610a can correspond to a third region, and image 612a can correspond to a fourth region relative to three-dimensional environment 602a. In some examples, the first through fourth regions are different from one another. For example, quadrants of a three-dimensional environment including virtual stage 606 can be determined by electronic device 101, such as quadrants formed by perpendicular lines that intersect at a center of virtual stage 606. When the viewpoint of electronic device 101 corresponds to a given quadrant, electronic device 101 can display a background image located opposite of the quadrant.

Spatial arrangement 614 illustrates a top-down view of a three-dimensional environment including virtual stage 606 while the viewpoint of electronic device 101 correspond to a bottom quadrant of the three-dimensional environment. In accordance with a determination that the viewpoint corresponds to the bottom quadrant, electronic device 101 can display background image 604a. Background image 604a can, for example, correspond to virtual content from a virtual scene or a predefined image specified by a computer system in communication with electronic device 101.

Spatial arrangement 616 illustrates the viewpoint of electronic device 101 located within a top quadrant of the three-dimensional environment. In the example of spatial arrangement 616, electronic device 101 can display image 610a, and forgo display of other images (e.g., image 604a) in response to detecting the movement of the viewpoint enter the top quadrant of the three-dimensional environment.

Spatial arrangement 618 illustrates the viewpoint of electronic device 101 located within a rightmost quadrant of the three-dimensional environment. In the example of spatial arrangement 618, electronic device 101 can display image 612a, and forgo display of other images (e.g., image 604a and/or image 610a) in response to detecting the movement of the viewpoint enter the rightmost quadrant of the three-dimensional environment.

Spatial arrangement 620 illustrates the viewpoint of electronic device 101 located within a leftmost quadrant of the three-dimensional environment. In the example of spatial arrangement 620, electronic device 101 can display image 608a, and forgo display of other images (e.g., image 604a, image 610a, and/or image 612a) in response to detecting the movement of the viewpoint enter the leftmost quadrant of the three-dimensional environment.

In some examples, electronic device 101 partitions the three-dimensional environment into a greater or fewer number of segments than as described above. Consequentially, electronic device 101 can display a different number of images, each of which optionally corresponding to a segment of the three-dimensional environment. Additionally or alternatively, electronic device 101 can present two-dimensional images curving and/or bending in a third dimension, such as a two-dimensional image that forms a curved canvas. The curved canvas, for example, can curve along the stage. Displaying one or more images corresponding to a virtual scene can reduce the processing required to render and display a more detailed view of the depth of the virtual scene and can reduce the likelihood that position of background virtual content included in the images can remain at a predictable position and/or orientation relative to a virtual stage.

FIG. 7 illustrates examples of an electronic device generating a multi-planar image according to examples of the disclosure. In some examples, electronic device 101 generates a plurality of planes and/or volumes (e.g., volumes 704, 708, and 710) which correspond to different depths relative to a virtual stage (e.g., virtual stage 706) in three-dimensional environment 702. In some examples, electronic device 101 can generate a virtual background by combining virtual content from a virtual scene at depths corresponds to the depths of the plurality of planes and/or volumes relative to virtual stage 706.

As shown in FIG. 7, electronic device 101 generate and/or receives an indication of a virtual stage 706. Virtual stage 706 can be similar to or the same as other virtual stages described above. In some examples, to render virtual background content for a virtual scene, electronic device 101 can determine what portions of virtual content could be visible from the virtual stage 706 at the depths of volumes 704, 708, 710 and additional or alternative volumes. Thus, electronic device 101 can generate a depth map between virtual stage 706 and the portions of the virtual scene (e.g., defined by the quantity and/or size of volumes used to generate a virtual background).

In some examples, the determination is similar to capturing cross-sectional slices of the three-dimensional environment, where each slice corresponds to a face of a volume. For example, volume 704 can correspond to a first range of depths relative to virtual stage 706. In such an example, electronic device 101 can detect what virtual content such as virtual objects and/or textures are at locations that coincide with the faces of volume 704. Electronic device 101 can similarly detect the virtual content that coincides with the faces of volume 708 and with the faces of volume 710. By detecting which virtual content coincides with the faces, electronic device 101 can determine what aspects of the virtual scene are likely to be visible from within virtual stage 706.

Based on the detected visible portions of virtual content that coincide with the volumes, electronic device 101 can form one or more composite images using the visible portions of the virtual content. For example, a virtual rock can be visible at a depth corresponding to volume 708 (e.g., there is not virtual object that coincides with volume 704). In some examples, a composite image can be used for a virtual background. In the example described previously, the virtual background can include the virtual rock (e.g., when the viewpoint of electronic device 101 is oriented toward the virtual rock). Displaying a virtual scene using one or more volumes as described with reference to FIG. 7 reduces the processing required to render and display a more detailed representation of the virtual background, thereby improving efficiency of electronic device 101.

In some examples, electronic device 101 can participate in a multi-user communication session. In some examples, the multi-user communication session can include electronic device 101 and additional or alternative electronic devices and/or computer systems. In some examples, devices participating in the multi-user communication session can be headset computing devices and/or desktop or laptop computing devices. In some examples, mobile devices such as headsets can communicate spatial data with each other to simulate a sharing of a physical environment by placing representations of other users within respective three-dimensional environment of the headset devices. In some examples, the devices display a virtual stage at a shared position relative to a physical and/or a virtual environment. In some examples, the devices display a view of a virtual scene relative to the virtual stage based on the viewpoint of respective devices relative to the virtual stage. For example, electronic device 101 can display a first perspective based on a viewpoint of electronic device 101 relative to the virtual stage, and another device can display a second perspective based on a viewpoint of the other device relative to the virtual stage (e.g., the other device can perform one or more operations similar to, or the same as described with reference to electronic device 101 herein). Thus, the devices participating in the multi-user communication can exchange spatial data to simulate a sharing of a physical space (and/or the devices can share a same physical space), and can each present unique views of a virtual scene. In such examples, each device can use a first and/or a second rendering technique to render content from a shared virtual scene in a manner similar to or the same as described with reference to various examples herein. In some examples, a desktop computing device can display a two-dimensional view of the perspectives of one or each device participating in the multi-user communication session. In this way, the users of the multi-user communication session can discuss and/or interact with a virtual scene dynamically and in real time, without waiting for a packaging and/or sending of scenic data and/or commentary about renders of the scenic data.

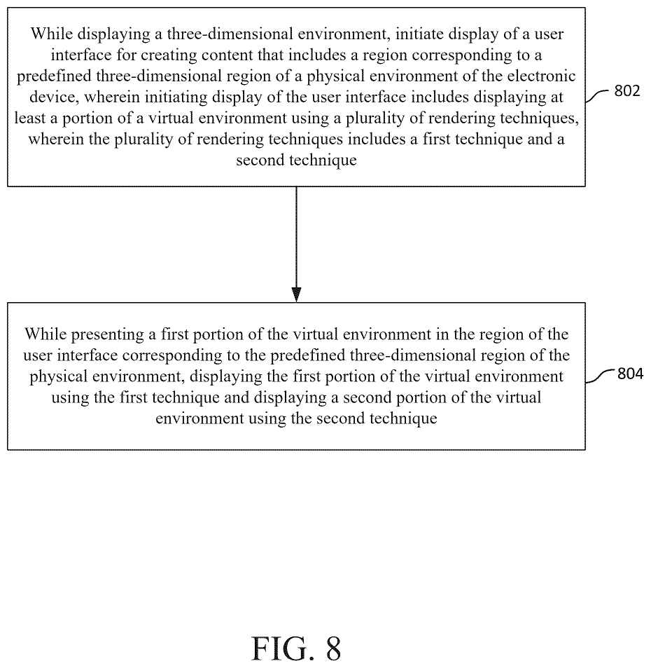

FIG. 8 is a flow chart of a method 800 of updating a virtual seating arrangement according to some examples of the disclosure. In some examples, instructions for executing method 800 are stored using a (e.g., non-transitory) computer readable storage medium, and executing the instructions causes an electronic device (e.g., electronic device 101 or electronic device 201) to perform method 800.

At 802, in some examples, while displaying a three-dimensional environment, the electronic device initiates display of a user interface for creating content, such as a user interface including stage 306 that includes a region corresponding to a predefined three-dimensional region of a physical environment of the electronic device, such as the physical environment occupied by stage 306 as shown in FIG. 3C, wherein initiating display of the user interface includes displaying at least a portion of a virtual environment using a plurality of rendering techniques, wherein the plurality of rendering techniques includes a first technique and a second technique, such as the first rendering technique used to render first content 324 as shown in FIG. 3A and a second rendering technique, such as a rendering technique used to render background 304 as shown in FIG. 3B. At 804, in some examples, while presenting a first portion of the virtual environment in the region of the user interface corresponding to the predefined three-dimensional region of the physical environment, the electronic device displays the first portion of the virtual environment using the first technique and displays a second portion of the virtual environment using the second technique, such as a rendering technique used to render first content 324 as shown in FIG. 3A and a second rendering technique, such as a rendering technique used to render background 304 as shown in FIG. 3B.

Additionally or alternatively, in some examples, a viewpoint of a user of the electronic device is a first viewpoint while displaying the first portion of the virtual environment using the first technique and while displaying the second portion of the virtual environment using the second technique, and in some examples, method 800 includes: in response to detecting a change in the viewpoint from the first viewpoint to a second viewpoint, different from the first viewpoint, displaying a third portion of the virtual environment, different from the second portion of the virtual environment, with the second technique. Additionally or alternatively, in some examples, a viewpoint of a user of the electronic device is a first viewpoint while displaying the first portion of the virtual environment using the first technique and while displaying the second portion of the virtual environment using the second technique, and in some examples, method 800 further comprises, in response to detecting a change in the viewpoint from the first viewpoint to a second viewpoint, different from the first viewpoint, maintaining display of the first portion of the virtual environment using the first technique. Additionally or alternatively, in some examples, a viewpoint of a user of the electronic device is a first viewpoint while displaying the first portion of the virtual environment using the first technique and while displaying the second portion of the virtual environment using the second technique, and in some examples, method 800 further includes, in response to detecting a change in the viewpoint from the first viewpoint to a second viewpoint, different from the first viewpoint: ceasing display of the first portion of the virtual environment using the first technique; and initiating display of a third portion, different from the first portion, of the virtual environment using the first technique. Additionally or alternatively, in some examples, the second portion of the virtual environment is a predetermined portion of the virtual environment that is predetermined when display of the user interface is initiated. Additionally or alternatively, in some examples, method 800 includes, while displaying the first portion of the virtual environment using the first technique and while displaying the second portion of the virtual environment using the second technique, receiving one or more inputs modifying a size of the region corresponding to the predefined three-dimensional region of the environment relative to the three-dimensional environment, and in response to receiving the one or more inputs, modifying the size of the region; and displaying a third portion of the virtual environment using the first technique, wherein the size of the portion of the virtual environment is changed in accordance with the one or more inputs. Additionally or alternatively, in some examples, method 800 includes, while displaying the first portion of the virtual environment using the first technique and while displaying the second portion of the virtual environment using the second technique, receiving one or more inputs modifying a position of the region relative to the three-dimensional environment; and in response to receiving the one or more inputs, ceasing display of at least a respective portion of the first portion of the virtual environment. Additionally or alternatively, in some examples, the second portion of the virtual environment corresponds to a projection of a viewpoint of a user of the electronic device relative to the region corresponding to the predefined three-dimensional region of the physical environment. Additionally or alternatively, in some examples, displaying the second portion of the virtual environment includes generating a depth map between a viewpoint of a user of the electronic device and the region corresponding to the predefined three-dimensional region of the physical environment, and displaying one or more images based on respective virtual content corresponding to a plurality of depths included in the depth map. Additionally or alternatively, in some examples, method 800 includes, streaming, from a computer system different from the electronic device, information representative of the virtual environment, wherein respective content included in the first portion of the virtual environment is based on the information. Additionally or alternatively, in some examples, method 800 includes, while displaying the first portion of the virtual environment using the first technique and while displaying the second portion of the virtual environment using the second technique, receiving an indication to change which respective virtual content is included in the region of the user interface corresponding to the predefined three-dimensional region of the physical environment from a computer system other than the electronic device, and in response to receiving the indication, displaying a third portion of the virtual environment, different from the first portion of the virtual environment, with the first technique in the region corresponding to the predefined three-dimensional region of the physical environment; and displaying fourth portion of the virtual environment, different from the second portion of the virtual environment, with the second technique. Additionally or alternatively, in some examples, the first technique and the second technique are defined by a user of the electronic device before initiating display of the user interface for creating content. Additionally or alternatively, in some examples, method 800 includes, while displaying the first portion of the virtual environment, communicating first information corresponding to a first viewpoint of a user of the electronic device relative to the first portion of the virtual environment to a computer system other than the electronic device. Additionally or alternatively, in some examples, the plurality of rendering techniques includes a third technique, and initiating display of the virtual environment includes: while displaying the first portion of the virtual environment using the first technique and while displaying the second portion of the virtual environment using the second technique, initiating display of a third portion of the virtual environment, different from the first portion of the virtual environment and the second portion of the virtual environment, with the third technique of the plurality of rendering techniques. Additionally or alternatively, in some examples, displaying the second portion of the virtual environment with the second technique includes displaying respective virtual content corresponding to one or more visual features included in a two-dimensional image, the one or more visual features in the two-dimensional image are arranged with a determined first spatial arrangement, and the respective virtual content is displayed within the three-dimensional environment with a second spatial arrangement that corresponds to the first spatial arrangement. Additionally or alternatively, in some examples, the virtual environment is shared with one or more other electronic devices, different from the electronic device, via a multi-user communication session. Additionally or alternatively, in some examples, method 800 includes, while presenting a third portion of the virtual environment in the region of the user interface corresponding to the predefined three-dimensional region of the physical environment, displaying the third portion of the virtual environment using the first technique and displaying a fourth portion of the virtual environment using the second technique.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more input devices and one or more displays:
while displaying a three-dimensional environment, initiating display of a user interface for creating content that includes a region corresponding to a predefined three-dimensional region of a physical environment of the electronic device, wherein initiating display of the user interface includes displaying at least a portion of a virtual environment using a plurality of rendering techniques, wherein the plurality of rendering techniques includes a first technique and a second technique, the method further comprising:
while presenting a first portion of the virtual environment in the region of the user interface corresponding to the predefined three-dimensional region of the physical environment, displaying the first portion of the virtual environment using the first technique and displaying a second portion of the virtual environment using the second technique.

2. The method of claim 1, further comprising:
while displaying the first portion of the virtual environment using the first technique and while displaying the second portion of the virtual environment using the second technique, receiving one or more inputs modifying a size of the region corresponding to the predefined three-dimensional region of the environment relative to the three-dimensional environment; and
in response to receiving the one or more inputs:
modifying the size of the region; and
displaying a third portion of the virtual environment using the first technique, wherein the size of the portion of the virtual environment is changed in accordance with the one or more inputs.

3. The method of claim 1, wherein:
the second portion of the virtual environment corresponds to a projection of a viewpoint of a user of the electronic device relative to the region corresponding to the predefined three-dimensional region of the physical environment.

4. The method of claim 1, wherein displaying the second portion of the virtual environment includes:
generating a depth map between a viewpoint of a user of the electronic device and the region corresponding to the predefined three-dimensional region of the physical environment, and
displaying one or more images based on respective virtual content corresponding to a plurality of depths included in the depth map.

5. The method of claim 1, further comprising:
streaming, from a computer system different from the electronic device, information representative of the virtual environment, wherein respective content included in the first portion of the virtual environment is based on the information.

6. The method of claim 1, further comprising:
while displaying the first portion of the virtual environment using the first technique and while displaying the second portion of the virtual environment using the second technique, receiving an indication to change which respective virtual content is included in the region of the user interface corresponding to the predefined three-dimensional region of the physical environment from a computer system other than the electronic device; and
in response to receiving the indication:
displaying a third portion of the virtual environment, different from the first portion of the virtual environment, with the first technique in the region corresponding to the predefined three-dimensional region of the physical environment; and
displaying a fourth portion of the virtual environment, different from the second portion of the virtual environment, with the second technique.

7. The method of claim 1, wherein:
displaying the second portion of the virtual environment with the second technique includes displaying respective virtual content corresponding to one or more visual features included in a two-dimensional image,
the one or more visual features in the two-dimensional image are arranged with a determined first spatial arrangement, and
the respective virtual content is displayed within the three-dimensional environment with a second spatial arrangement that corresponds to the determined first spatial arrangement.

8. The method of claim 1, wherein the virtual environment is shared with one or more other electronic devices, different from the electronic device, via a multi-user communication session.

9. An electronic device that is in communication with one or more displays and one or more input devices, the electronic device comprising:
one or more processors;
memory; and
one or more programs, wherein the one or more programs are stored in the memory and configured to be executed by the one or more processors, the one or more programs including instructions for:
while displaying a three-dimensional environment, initiating display of a user interface for creating content that includes a region corresponding to a predefined three-dimensional region of a physical environment of the electronic device, wherein initiating display of the user interface includes displaying at least a portion of a virtual environment using a plurality of rendering techniques, wherein the plurality of rendering techniques includes a first technique and a second technique, the method further comprising:
while presenting a first portion of the virtual environment in the region of the user interface corresponding to the predefined three-dimensional region of the physical environment, displaying the first portion of the virtual environment using the first technique and displaying a second portion of the virtual environment using the second technique.

10. A non-transitory computer readable storage medium storing one or more programs, the one or more programs comprising instructions, which when executed by one or more processors of an electronic device that is in communication with one or more displays and one or more input devices, cause the computer system to perform a method comprising:
while displaying a three-dimensional environment, initiating display of a user interface for creating content that includes a region corresponding to a predefined three-dimensional region of a physical environment of the electronic device, wherein initiating display of the user interface includes displaying at least a portion of a virtual environment using a plurality of rendering techniques, wherein the plurality of rendering techniques includes a first technique and a second technique, the method further comprising:
while presenting a first portion of the virtual environment in the region of the user interface corresponding to the predefined three-dimensional region of the physical environment, displaying the first portion of the virtual environment using the first technique and displaying a second portion of the virtual environment using the second technique.

11. The electronic device of claim 9, further comprising:
while displaying the first portion of the virtual environment using the first technique and while displaying the second portion of the virtual environment using the second technique, receiving one or more inputs modifying a size of the region corresponding to the predefined three-dimensional region of the environment relative to the three-dimensional environment; and
in response to receiving the one or more inputs:
modifying the size of the region; and
displaying a third portion of the virtual environment using the first technique, wherein the size of the portion of the virtual environment is changed in accordance with the one or more inputs.

12. The electronic device of claim 9, wherein:
the second portion of the virtual environment corresponds to a projection of a viewpoint of a user of the electronic device relative to the region corresponding to the predefined three-dimensional region of the physical environment.

13. The electronic device of claim 9, wherein displaying the second portion of the virtual environment includes:
generating a depth map between a viewpoint of a user of the electronic device and the region corresponding to the predefined three-dimensional region of the physical environment, and
displaying one or more images based on respective virtual content corresponding to a plurality of depths included in the depth map.

14. The electronic device of claim 9, further comprising:
streaming, from a computer system different from the electronic device, information representative of the virtual environment, wherein respective content included in the first portion of the virtual environment is based on the information.

15. The electronic device of claim 9, wherein the virtual environment is shared with one or more other electronic devices, different from the electronic device, via a multi-user communication session.

16. The non-transitory computer readable storage medium of claim 10, further comprising:
while displaying the first portion of the virtual environment using the first technique and while displaying the second portion of the virtual environment using the second technique, receiving one or more inputs modifying a size of the region corresponding to the predefined three-dimensional region of the environment relative to the three-dimensional environment; and
in response to receiving the one or more inputs:
modifying the size of the region; and
displaying a third portion of the virtual environment using the first technique, wherein the size of the portion of the virtual environment is changed in accordance with the one or more inputs.

17. The non-transitory computer readable storage medium of claim 10, wherein:
the second portion of the virtual environment corresponds to a projection of a viewpoint of a user of the electronic device relative to the region corresponding to the predefined three-dimensional region of the physical environment.

18. The non-transitory computer readable storage medium of claim 10, wherein displaying the second portion of the virtual environment includes:
generating a depth map between a viewpoint of a user of the electronic device and the region corresponding to the predefined three-dimensional region of the physical environment, and
displaying one or more images based on respective virtual content corresponding to a plurality of depths included in the depth map.

19. The non-transitory computer readable storage medium of claim 10, further comprising:
streaming, from a computer system different from the electronic device, information representative of the virtual environment, wherein respective content included in the first portion of the virtual environment is based on the information.

20. The non-transitory computer readable storage medium of claim 10, wherein the virtual environment is shared with one or more other electronic devices, different from the electronic device, via a multi-user communication session.
